(19) United States
(12) Patent Application Publication
(10) Pub. No.: US 2006/0117915 A1
(43) Pub. Date: Jun. 8, 2006

(54) Anti-wearing socket and inner lining thereof

(76) Inventor: David Hui, Taipei (TW)

Correspondence Address: David Hui, P.O. Box 55-846, Taipei, 104, TW

(21) Appl. No.: 11/003,713

(22) Filed: Dec. 6, 2004

(51) Int. Cl. B25B 13/06

(52) U.S. Cl. 81/124.4; 81/121.1; 81/125.1

(57) ABSTRACT

A socket includes an inner lining detachably formed in an inner hole within the socket, with the inner lining formed therein with a differentially-sized torque recess including at least a large hexagonal hole defining a large diagonal distance (D₁) between two diagonal points of the large hexagonal hole and a small hexagonal hole gradationally contracted inwardly from the large hexagonal hole and defining a small diagonal distance (D₂) between two diagonal points of the small hexagonal hole, so that each inner lining may be provided for selectively engaging at least two differently-sized nuts (or bolts) for convenient and economic torquing purpose.

### BACKGROUND OF THE INVENTION

U.S. Pat. No. 6,397,706 to Peter J. Maznicki disclosed a protective socket adapted to torque a head of a hardware fastener, having a non-marring inner lining disposed within an outer sleeve of the socket for protecting the hardware from being marred.

However, such a prior art disclosed the inner lining (14) of unique size of only one torquing hole (20) provided within the lining (14) so that a plurality of linings should be prepared ready for insertion into differently-sized torquing holes of differently-sized hardware fasteners, thereby causing maintenance inconvenience and possibly increasing the implementation cost for mechanical jobs or maintenance work.

The present inventor has found the drawbacks of the prior art and invented the present socket having differentially-sized torque hole formed in an inner lining in the socket adapted for a convenient, economic and efficient selective engagement of proper nut or bolt with the lining for enhancing anti-wearing effect for the nut or bolt and the socket.

### SUMMARY OF THE INVENTION

The object of the present invention is to provide a socket including an inner lining detachably formed in an inner hole within the socket, with the inner lining formed therein with a differentially-sized torque recess including at least a large hexagonal hole defining a large diagonal distance (D₁) between two diagonal points of the large hexagonal hole and a small hexagonal hole gradationally contracted inwardly from the large hexagonal hole and defining a small diagonal distance (D₂) between two diagonal points of the small hexagonal hole, so that each inner lining may be provided for selectively engaging at least two differently-sized nuts (or bolts) for convenient and economic torquing purpose.

### BRIEF DESCRIPTION OF THE DRAWINGS

FIG. 1 is a sectional drawing of the present invention.

FIG. 2 is a cross sectional drawing of the present invention as viewed from 2-2 line of FIG. 1.

FIG. 3 is a sectional drawing of another preferred embodiment of the present invention.

### DETAILED DESCRIPTION

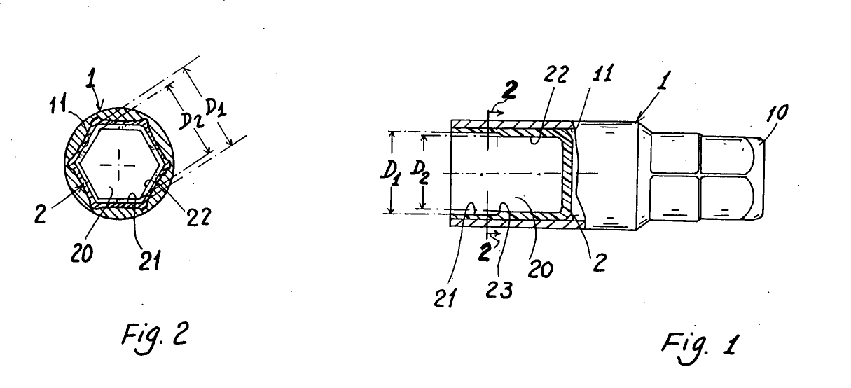

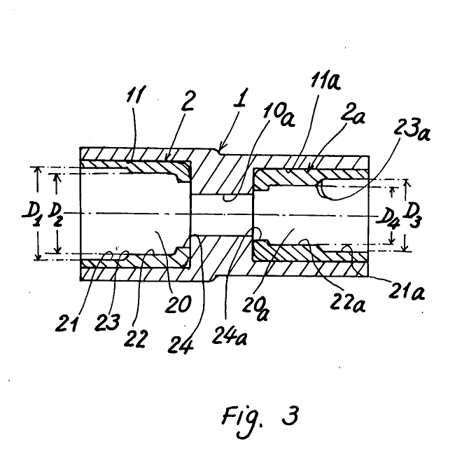

As shown in FIGS. 1 and 2, an anti-wearing socket 1 of the present invention comprises: an inner lining 2 formed or detachably formed in an inner hole 11 recessed in the socket 1, having a driving head portion 10 formed on a top portion of the socket 1 opposite to the inner hole 11 and adapted for engaging a tool including a wrench for driving the socket and accordingly driving a nut or bolt (not shown) inserted or engaged in a torque recess 20 recessed in the inner lining 2.

The torque recess 20 recessed in the inner lining 2 includes a large hexagonal hole 21 defining a large diagonal distance D₁ between two diagonal points of the large hexagonal hole 21, and a small hexagonal hole 22 gradationally contracted inwardly from the large hexagonal hole 21 and defining a small diagonal distance D₂ between two diagonal points of the small hexagonal hole 22, with the small diagonal distance D₂ being smaller (or shorter) than the large diagonal distance D₁, so that each inner lining 2 as formed in the socket 1 may be selectively engaged with a large nut (or bolt) or engaged with a small nut (or bolt) in the respective corresponding hexagonal hole 21 or 22.

Accordingly, one lining 2 in the socket 1 may be provided for respectively engaging two nuts (or bolts) different in size. By the way, the cost for factory implementation can be reduced and the torquing or maintenance job may be done more conveniently, economically and efficiently.

The torque recess 20 in the inner lining 2 may further include a tapered portion 23 formed in between the large hexagonal hole 21 and the small hexagonal hole 22, with the tapered portion 23 concentrically tapered inwardly from the large hexagonal hole 21 towards the small hexagonal hole 22 for a smooth and quick insertion of a small nut (or bolt) from the large hexagonal hole 21 into the small hexagonal hole 22.

The inner lining 2 may be detachably formed, inserted, embedded or secured in the inner hole 11 as recessed in the socket 1.

The inner lining 2 may also be fixedly secured, coated, deposited, or formed in situ on an inner surface of the inner hole 11 within the socket 1, not limited in the present invention.

The inner lining 2 may be made of plastic, rubber, composite or elastomer materials, but not limited in the present invention.

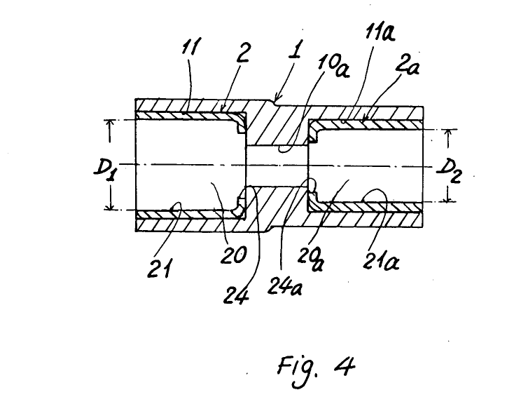

As shown in FIG. 3, another preferred embodiment of the present invention is illustrated, which comprises a socket 1 having two inner holes 11, 11a having different size recessed in opposite end portions of the socket 1, having an intermediate driving polygonal (e.g., square) hole 10a formed in a middle section in the socket 1 between the two inner holes 11, 11a; a first inner lining 2 formed or detachably formed in a first inner hole 11 recessed in a left side portion of the socket 1, a first torque recess 20 recessed in the first inner lining 2 including a first-sized hexagonal hole 21 defining a first-sized diagonal distance D₁ between two diagonal points of the first-sized hexagonal hole 21, and a second-sized hexagonal hole 22 gradationally contracted inwardly from the first-sized hexagonal hole 21 and defining a second-sized diagonal distance D₂ between two diagonal points of the second-sized hexagonal hole 22, with the second-sized diagonal distance D₂ being smaller than the first-sized diagonal distance D₁, so that the first inner lining 2 as formed in a left side of the socket 1 may be selectively engaged with two nuts (or bolts) of two size, i.e., as first-sized and second-sized; and a second inner lining 2a formed or detachably formed in a second inner hole 11a recessed in a right side portion of the socket 1, a second torque recess 20a, smaller than the first torque recess 20, recessed in the second inner lining 2a including a third-sized hexagonal hole 21a smaller than the second-sized hexagonal hole 22 and defining a third-sized diagonal distance D₃ between two diagonal points of the third-sized hexagonal hole 21a, and a fourth-sized hexagonal hole 22a gradationally contracted inwardly from the third-sized hexagonal hole 21a and defining a fourth-sized diagonal distance D₄ between two diagonal points of the fourth-sized hexagonal hole 22a, with the fourth-sized diagonal distance D₄ being smaller than the third-sized diagonal distance D₃, so that the second inner lining 2a as formed in the right side of the socket 1 may be selectively engaged with further two nuts (or bolts) as third-sized and fourth-sized.

Therefore; the two inner linings 2, 2a as provided in the socket 1 as shown in FIG. 3 may be engaged with four differently-sized nuts (or bolts) having their size gradually reduced. The size sequence of the diagonal distance is: D₁>D₂>D₃>D₄.

Naturally, each inner lining 2 or 2a may be formed with a torque recess having a plurality of differently-sized diagonal holes gradationally formed in each torque recess, not limited to be two diagonal holes 21, 22 (or 21a, 22a) as shown in the accompanying drawings in this invention.

The present invention may be modified without departing from the spirit and scope of the present invention.

For instance, a further preferred embodiment as shown in FIG. 4 is given, in which the first inner lining 2 as formed in the first (left) inner hole 11 is modified to include a first-sized hexagonal hole 21 defining a first-sized diagonal distance D₁, and the second inner lining 2a as formed in the second (right) inner hole 11a is modified to include a second-sized hexagonal hole 21a defining a second-sized diagonal distance D₂, so that either the left side lining 2 or the right side lining 2a may be selectively engaged with a large nut (or bolt) or a small nut (or bolt).

As shown in FIGS. 3, 4, each lining 2 or 2a should be formed with a through hole 24, 24a through an inner end cover of each lining for driving the socket.

The present invention may be used for engaging a nut or bolt of polygonal shapes.

I claim:

1. A socket comprising an inner lining formed in an inner hole within the socket, said inner lining having a differentially-sized torque recess recessed in said lining, and including at least a large hexagonal hole defining a large diagonal distance (D₁) between two diagonal points of the large hexagonal hole for engaging a large nut or bolt, and a small hexagonal hole gradationally contracted inwardly from the large hexagonal hole and defining a -small diagonal distance (D₂) between two diagonal points of the small hexagonal hole for engaging a small nut or bolt.

2. A socket according to claim 1, where said torque recess in the inner lining further include a tapered portion formed in between the large hexagonal hole and the small hexagonal hole, with the tapered portion concentrically tapered inwardly from the large hexagonal hole towards the small hexagonal hole for a smooth and quick insertion of a small nut or bolt from the large hexagonal hole into the small hexagonal hole.

3. A socket according to claim 1, where said inner lining is detachably formed, inserted, embedded or secured in the inner hole as recessed in the socket.

4. A socket according to claim 1, where said inner lining is fixedly secured, coated, deposited, or formed in situ on an inner surface of the inner hole within the socket.

5. A socket according to claim 1, where said inner lining is made of plastic, rubber, composite or elastomer materials.

6. An inner lining adapted to be formed in a socket having the limitations as set forth in claim 1.

7. A socket having two inner holes with different size recessed in opposite end portions of the socket, having an intermediate driving polygonal hole formed in a middle section in the socket between the two inner holes; said socket comprising a first inner lining formed in a first inner hole recessed in a left side portion of the socket, having a first torque recess recessed in the first inner lining, and including a first-sized hexagonal hole defining a first-sized diagonal distance (D₁) between two diagonal points of the first-sized hexagonal hole, and a second-sized hexagonal hole gradationally contracted inwardly from the first-sized hexagonal hole and defining a second-sized diagonal distance (D₂) between two diagonal points of the second-sized hexagonal hole, with the second-sized diagonal distance (D₂) being smaller than the first-sized diagonal distance (D₁), so that the first inner lining as formed in a left side of the socket is selectively engaged with two nuts or bolts as first-sized and second-sized; and a second inner lining formed in a second inner hole recessed in a right side portion of the socket, having a second torque recess, smaller than the first torque recess, recessed in the second inner lining, and including a third-sized hexagonal hole smaller than the second-sized hexagonal hole and defining a third-sized diagonal distance (D₃) between two diagonal points of the third-sized hexagonal hole, and a fourth-sized hexagonal hole gradationally contracted inwardly from the third-sized hexagonal hole and defining a fourth-sized diagonal distance (D₄) between two diagonal points of the fourth-sized hexagonal hole, with the fourth-sized diagonal distance (D₄) being smaller than the third-sized diagonal distance (D₃), so that the second inner lining as formed in the right side of the socket is selectively engaged with further two nuts or bolts as third-sized and fourth-sized.

8. A socket according to claim 7, where said inner lining is detachably secured in said inner hole formed in said socket.

9. A socket having two inner holes with different size recessed in opposite end portions of the socket, having an intermediate driving polygonal hole formed in a middle section in the socket between the two inner holes; said socket comprising a first inner lining detachably formed in a first inner hole recessed in a left side portion of the socket, having a first-sized hexagonal hole defining a first-sized diagonal distance (D₁) between two diagonal points of the first-sized hexagonal hole, the first inner lining as formed in a left side of the socket engaged with a nut or bolt as first-sized; and a second inner lining detachably formed in a second inner hole recessed in a right side portion of the socket, having a second-sized hexagonal hole smaller than the first-sized hexagonal hole and defining a second-sized diagonal distance (D₂) between two diagonal points of the second-sized hexagonal hole, the second inner lining as formed in the right side of the socket engaged with another nut or bolt as second-sized.

10. A socket according to claim 7, wherein each said lining is formed with a through hole through each said lining to be communicated with said intermediate polygonal hole formed in the middle section between said two inner holes.
